(19) United States
(12) Patent Application Publication
(10) Pub. No.: US 2018/0334180 A1
(43) Pub. Date: Nov. 22, 2018

(54) Stabilized Cart

(71) Applicant: Billy Wayne Lambert, Plant City, FL (US)

(72) Inventor: Billy Wayne Lambert, Plant City, FL (US)

(21) Appl. No.: 15/979,980

(22) Filed: May 15, 2018

Related U.S. Application Data
(60) Provisional application No. 62/506,638, filed on May 16, 2017.

(51) Int. Cl. B62B 3/00; B62B 5/00

(52) U.S. Cl. CPC B62B 3/002; B62B 2301/04; B62B 5/00

(57) ABSTRACT

A stabilized cart. The cart of the present invention having at least two side walls and a forward and rear end wall with a plurality of holders and outriggers for support during windy conditions. The cart has a plurality of wheels, preferably on casters, that allow for travel on sandy terrain. The stabilized cart is particularly helpful in sandy conditions during high wind events due to the outriggers which provide the cart with greater stability.

### CROSS REFERENCE TO RELATED APPLICATIONS

This application claims priority to Provisional Application No. 62/126,587 filed on May 16, 2017 and entitled “Stabilized Cart.” The content of that application is fully incorporated herein for all purposes.

### TECHNICAL FIELD

This disclosure relates to a stabilized cart. More specifically, this disclosure relates to a cart with a plurality of accoutrement holders and a set of outriggers for stability.

### BACKGROUND OF THE INVENTION

When attempting to bring items such as coolers, fishing rods, chairs, bags, and other desirable items to the beach, piers, docks, or other marine environments it can be difficult to carry a large amount of objects over a large distance as well as difficult to trek such objects over sand. There currently exist carts with sand wheels which are wheels with large diameters and treads designed specifically for sand travel. However, these carts do not incorporate umbrellas or holders for objects such as fishing rods or, if they do, are unstable in high wind conditions, which are common in marine environments. What is needed, therefore, is a stable cart capable of traveling on sand with an umbrella attachment which will not tip over in high wind conditions and which can be adjusted for different wind directions. The stabilized cart of the present disclosure fulfills these and other needs in the art.

Therefore, it is an object of this invention to provide an improvement which overcomes the aforementioned inadequacies of prior art devices and provides an improvement which is a significant contribution to the advancement of the relevant technology.

It is a further object of this invention to provide a cart having stabilizing outriggers so as to prevent tipping and movement in high wind conditions.

It is a further object of this invention to provide a cart that can be handled in sandy conditions while still maintaining a light weight so as not to require too much exertion.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

This disclosure provides a cart with a plurality of holders and stabilizing outriggers.

The disclosed system has several important advantages. For example, the cart can travel over sand with minimal effort.

A further possible advantage is achieved by providing a cart that comprises an umbrella for shade that can be locked into place.

A further possible advantage is achieved by providing a cart that has an umbrella that can be adjusted in different positions according to the direction of wind, sun, or rain.

Still yet another possible advantage of the present invention is to provide a cart that will not tip over in high wind situations.

Another advantage of the present invention is to provide a cart that comprises a plurality of holders for various items such as fishing rods and umbrellas.

Another advantage of the present invention is to provide a large retaining area so as to hold a variety of items.

Various embodiments of the invention may have none, some, or all of these advantages. Other technical advantages of the present invention will be readily apparent to one skilled in the art.

Embodiments of the present invention are herein described by way of example and directed to a phase change material utilizing an elastomeric matrix having lipids that change phase from solid to liquid at a low and high temperatures, which is then associated relative to a permeable layer, The aforementioned state of the art of phase change materials shows the need for improvements in phase change materials that can allow a therapeutic or cosmetic agent to be uniformly transferred, in part or in whole, from the permeable layer to the user, with varying heat and/or cold applications.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a rear view of the stabilized cart of the present invention.

FIG. 2 is a side view of the stabilized cart of the present invention.

FIG. 3 is a front view of the stabilized cart of the present invention.

Similar reference characters refer to similar parts throughout the several views of the figures.

### DETAILED DESCRIPTION OF THE DRAWINGS

The present invention relates to a stabilized cart. More specifically, the invention relates to a cart with a plurality of accoutrement holders and a set of outriggers for stability. The following description is of the best mode presently contemplated for carrying out the invention. This description is not to be taken in a limiting sense, but is made merely for the purpose of describing one or more preferred embodiments of the invention. The scope of the invention should be determined with reference to the claims.

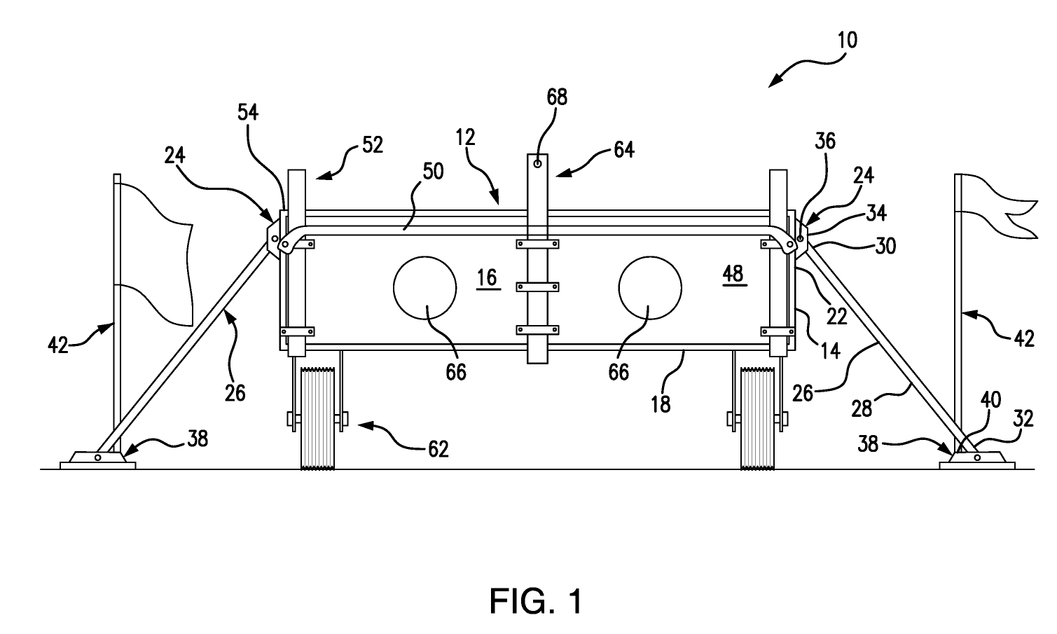

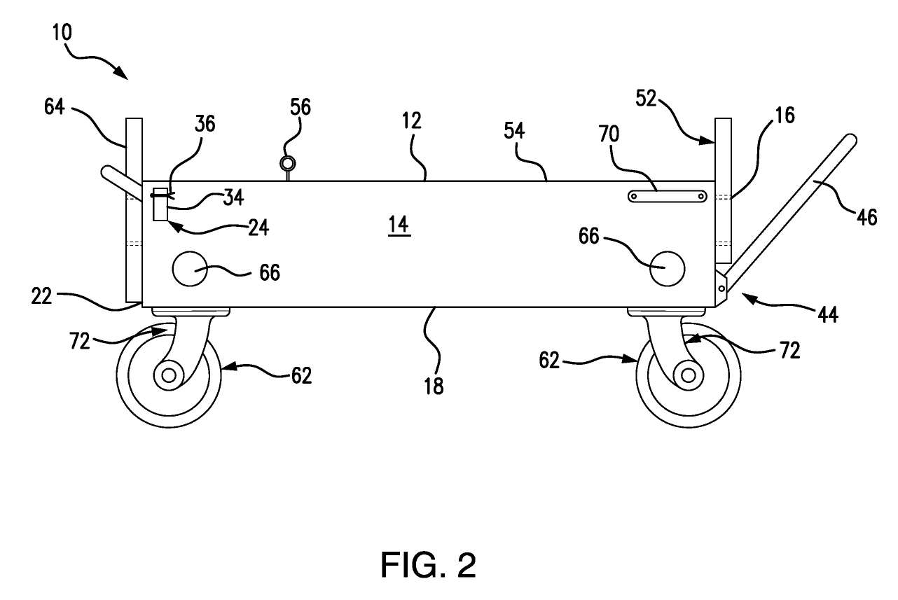

With reference now to FIGS. 1-3, the cart 10 comprises an interior area 12 for holding objects bounded by side walls 14 and end walls 16 and further comprises a flat base 18. Each side wall 14 has a proximal end 20 and distal end 22 and further comprises a outrigger bracket 24 attached to the distal end 22. The outrigger bracket 24 allows for the easy attachment and removal of outrigger 26 which further comprises a arm 28 having a proximal arm end 30 and distal arm end 32. The outrigger bracket 24 comprises a bracket 34 and pin 36 which inserts into a hole in the proximal arm end 30 of arm 28. The distal arm end 32 further comprises a rotatable foot 38 which allows for placement on uneven terrain. The rotatable foot 38 preferably further comprises a flag holder 40 for holding a flag 42 to alert others that the outrigger 26 is protruding from the cart 10. Further, the top edge 54 of the side walls 14 may feature eyelets 56 to be used as tie downs to put tie straps over any items placed within the interior area 12.

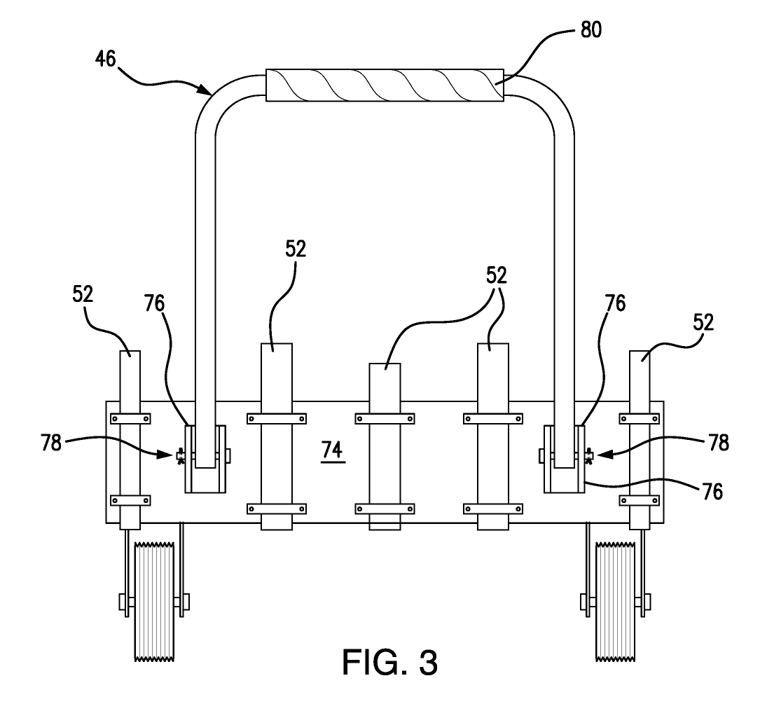

Preferably, the forward end wall 44 has a removable pull handle 46 to allow the user to pull the cart 10. The cart 10 may also have a plurality of handles 70 to allow for additional contact points and for loading/unloading from vehicles. Additionally, the rear end wall 48 may have a secondary handle 50 to allow the user to load and unload the cart 10 from a vehicle. With reference to FIG. 3, the forward end wall 74 may further comprise at least one handle bracket 76 with removable pin 78 for retention of removable pull handle 46. The pull handle 46 is preferably bound with foam 80. Further, in the preferred embodiment, the cart 10 comprises a plurality of holders 52 attached to the side walls 14 and end walls 16. These holders 52 can hold any number of items but are preferably used for fishing rods. The rear end wall 48 further comprises an adjustable umbrella holder 64 which is held in place using a pin 68. The side walls 14 and end walls 16 also may have reflectors 66 which allow for others to locate the cart during nighttime conditions.

The flat base 18 further comprises a base top 58 and base bottom 60. A plurality of wheels 62 are attached to the base bottom 60. The wheels 62 may be of any variety so long as they are appropriate for travel on sandy terrain. The wheels 62 may be attached to the base bottom by any means but preferably through the use of casters 72 with grease fittings. Further, the base bottom 60 preferably has a plurality of drain holes so as to allow any excess liquid that may accumulate from runoff or rain to exit the cart 10.

Preferably, the cart 10 has side walls 14 that are 36 inches in length and end walls 16 that are 24 inches in length. The wheels 62 are preferably 10 inches in diameter but may be any size that allows for travel on sandy terrain. The cart 10 is preferably made of aluminum, pressure treated plywood, and stainless/zinc-coated screws and bolts.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure. The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A cart comprising:
a pair of side walls and a forward end wall and a rear end wall connected by a flat base;
where each side wall further comprises a proximal end and a distal end having an outrigger bracket attached at the distal end;
a pair of retractable outriggers, each outrigger further comprising an arm having a proximal arm end and a distal arm end connected to the outrigger bracket, the outrigger bracket further comprising a bracket and a pin which inserts into the proximal arm end of the arm;
a rotatable foot comprising a holder connected to the distal arm end;
at least one eyelet attached to a top edge of each side wall;
the forward end wall having a removable handle bounded with foam comprising at least one handle bracket with a removable pin;
a plurality of holders attached to the side walls, forward end wall, and rear end wall;
a retaining holder comprising a pin;
a plurality of reflectors placed along the side walls, forward end wall, and rear end wall; and
the base further comprising a base top and base bottom wherein a plurality of wheels are attached the base bottom, the base bottom further comprising a plurality of drain holes.

2. The stabilized cart of claim 1 wherein each side wall is at least 36 inches long.

3. The stabilized cart of claim 1 wherein the forward end wall and rear end wall are at least 24 inches long.

4. The stabilized cart of claim 1 wherein the wheels are casters.

5. The stabilized cart of claim 4 wherein the wheels are 10 inches in diameter.

6. The stabilized cart of claim 1 wherein each side wall, the forward end wall, and the rear end wall are made of plywood.

7. The stabilized cart of claim 1 wherein the outrigger is made of aluminum.

8. A stabilized cart comprising:
a pair of side walls and a forward end wall and a rear end wall connected by a flat base;
a pair of retractable outriggers, each one singularly attached to each side wall using a outrigger bracket;
a removable handle attached to the rear end wall;
a retaining holder comprising a pin;
the base further comprising a base top and base bottom wherein a plurality of wheels are attached the base bottom, the base bottom further comprising a plurality of drain holes.

9. The stabilized cart of claim 8 wherein the retractable outriggers further comprise an arm having a proximal arm end and a distal arm end connected to the outrigger bracket further comprising a bracket and a pin which inserts into the proximal arm end of the arm.

10. The stabilized cart of claim 9 wherein the distal arm end further comprises a rotatable foot with a holder.

11. The stabilized cart of claim 8 wherein each side wall is at least 36 inches long.

12. The stabilized cart of claim 8 wherein the forward end wall and rear end wall are at least 24 inches long.

13. The stabilized cart of claim 8 wherein the wheels are casters.

14. The stabilized cart of claim 13 wherein the wheels are 10 inches in diameter.

15. The stabilized cart of claim 8 wherein each side wall, the forward end wall, and the rear end wall are made of plywood.

16. The stabilized cart of claim 8 wherein the outrigger is made of aluminum.

17. The stabilized cart of claim 8 wherein the stabilized cart further comprises a plurality of reflectors placed along the side walls, forward end wall, and rear end wall.

18. The stabilized cart of claim 8 wherein the outrigger bracket further comprises a bracket and a pin which inserts into a proximal arm end of the arm.
